(19) United States
(12) Patent Application Publication
(10) Pub. No.: US 2018/0332882 A1
(43) Pub. Date: Nov. 22, 2018

(54) Produce Washer

(71) Applicants: KS Technologies and Custom Manufacturing, LLC, Attica, OH (US); A.T.R. Innovations, LLC, Bowling Green, OH (US)

(72) Inventors: Brett Wansitler, Bowling Green, OH (US); Ronald Waldock, Attica, OH (US)

(73) Assignees: KS Technologies and Custom Manufacturing, LLC, Attica, OH (US); A.T.R. Innovations, LLC, Bowling Green, OH (US)

(21) Appl. No.: 15/982,667

(22) Filed: May 17, 2018

Related U.S. Application Data
(60) Provisional application No. 62/508,570, filed on May 19, 2017.

(51) Int. Cl. A23N 12/06; B08B 3/02; B08B 3/08

(52) U.S. Cl. CPC A23N 12/06; B08B 3/08; B08B 3/022

(57) ABSTRACT

Described are an apparatus and method for washing produce involving a produce washer having a conveyor belt defining openings therethrough.

### RELATED APPLICATIONS

This application claims priority to U.S. Provisional Application No. 62/508,570, filed under 35 U.S.C. § 111(b) on May 19, 2017, the disclosure of which is incorporated herein by reference in its entirety.

### BACKGROUND OF THE INVENTION

Produce, such as fruits and vegetables, need to be washed for food safety purposes. However, a spray providing fine water droplets with a substantial impact force would bruise or damage the produce. Furthermore, the use of a cleansing agent to wash produce may leave an unacceptable after-taste, or cause an acceptable chemical reaction with the produce that results in deterioration or damage to the produce. A high-temperature washing process would also wilt or otherwise damage the produce. Thus, there is a need for new and improved apparatuses and methods for washing produce.

### SUMMARY OF THE INVENTION

Provided is a produce washer comprising a modular housing having a plurality of zones extending between a first end and a second end, and a conveyor belt comprising a hygienic material and defining a conveyor belt surface running through the plurality of zones from the first end to the second end. The conveyor belt is configured to transport items on the conveyor belt surface from the first end to the second end, where the conveyor belt comprises openings configured to allow a liquid to be sprayed therethrough. The plurality of zones defines a washing zone and a sanitation zone. The washing zone comprises (i) nozzles disposed above the conveyor belt surface configured to spray a liquid onto objects traversing or within the washing zone on the conveyor belt surface, and (ii) nozzles disposed below the conveyor belt surface configured to spray a liquid onto objects traversing or within the washing zone on the conveyor belt surface through the openings in the conveyor belt. The sanitation zone comprises nozzles configured to spray a sanitized liquid onto objects traversing or within the sanitation zone on the conveyor belt surface from above the conveyor belt surface.

In certain embodiments, the washing zone further comprises directional nozzles on a side wall of the modular housing configured to spray a liquid onto objects traversing or within the washing zone on the conveyor belt surface.

In certain embodiments, the produce washer further comprises a rinsing zone, where the rinsing zone comprises nozzles configured to spray a liquid onto objects traversing or within the rinsing zone on the conveyor belt surface from above the conveyor belt surface.

In certain embodiments, the produce washer further comprises a drying zone comprising one or more overhead blow dryers.

In certain embodiments, the produce washer is free of brushes.

In certain embodiments, the producer washer includes one or more windows in the modular housing configured to allow observation into the produce washer.

In certain embodiments, the produce washer is level to the ground. In certain embodiments, the produce washer is tilted at an angle such that the first end is at a different height than the second end. In certain embodiments, the conveyor belt is level. In other embodiments, the conveyor belt is tilted at an angle such that the conveyor belt at the first end is at a different height than the conveyor belt at the second end.

In certain embodiments, the hygienic material comprises polypropylene, polyethylene, polyoxymethylene, polyacetal, or combinations thereof.

In certain embodiments, the openings make up about 36% of the conveyor belt surface.

In certain embodiments, the produce washer further includes a stand having a plurality of legs configured to support the modular housing. In particular embodiments, the stand further supports a cabinet. In particular embodiments, the cabinet houses at least one of, a supply of sanitized liquid, a pump, or a drive motor configured to run the conveyor belt.

In certain embodiments, the produce washer further includes an entrance roller kit connected to the first end. In certain embodiments, the produce washer further includes an exit conveyor connected to the second end. In certain embodiments, the produce washer further includes a waxer connected to the second end, wherein the waxer comprises rollers and is configured such that objects exiting the conveyor belt accumulate wax upon traversing the rollers of the waxer.

Further provided is a method of washing produce, the method comprising moving produce through a produce washer along a conveyor belt composed of a hygienic material and comprising openings configured to allow a liquid to be sprayed therethrough, and spraying a liquid onto the produce from above the produce and from below the produce while the produce is moving through the produce washer, where the liquid sprayed from below the produce is sprayed through the openings in the conveyor belt.

In certain embodiments, the produce washer is free of brushes. In certain embodiments, the liquid comprises water. In certain embodiments, the liquid comprises sanitized water. In certain embodiments, the openings make up about 36% of a surface of the conveyor belt.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Side elevational view of an embodiment of a produce washer.

FIG. 2: Top cutaway view of an embodiment of a produce washer.

FIG. 3: Side cutaway view of an embodiment of a produce washer.

FIG. 4: End cutaway view of an embodiment of a produce washer.

FIGS. 5A-5B: Non-limiting example embodiments of conveyor belt segments.

FIGS. 6A-6B: Side views of a conveyor belt segment, without (FIG. 6A) and with (FIG. 6B) teeth for enhanced gripping of objects.

FIG. 7: Non-limiting example conveyor belt.

FIGS. 8A-8B: Front elevational (FIG. 8A) and back elevational (FIG. 8B) views of an optional waxer.

FIGS. 9A-9B: Front elevational (FIG. 9A) and back elevational (FIG. 9B) views of an entrance roller kit.

FIGS. 10A-10B: Front elevational (FIG. 10A) and back elevational (FIG. 10B) views of an exit conveyor.

### DETAILED DESCRIPTION OF THE INVENTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided herein is a brushless, high-volume, continuous duty produce washer. Though produce is described for exemplary purposes, it is understood that the produce washer may be used to wash other items, including other food items, and such uses are entirely within the scope of the present disclosure.

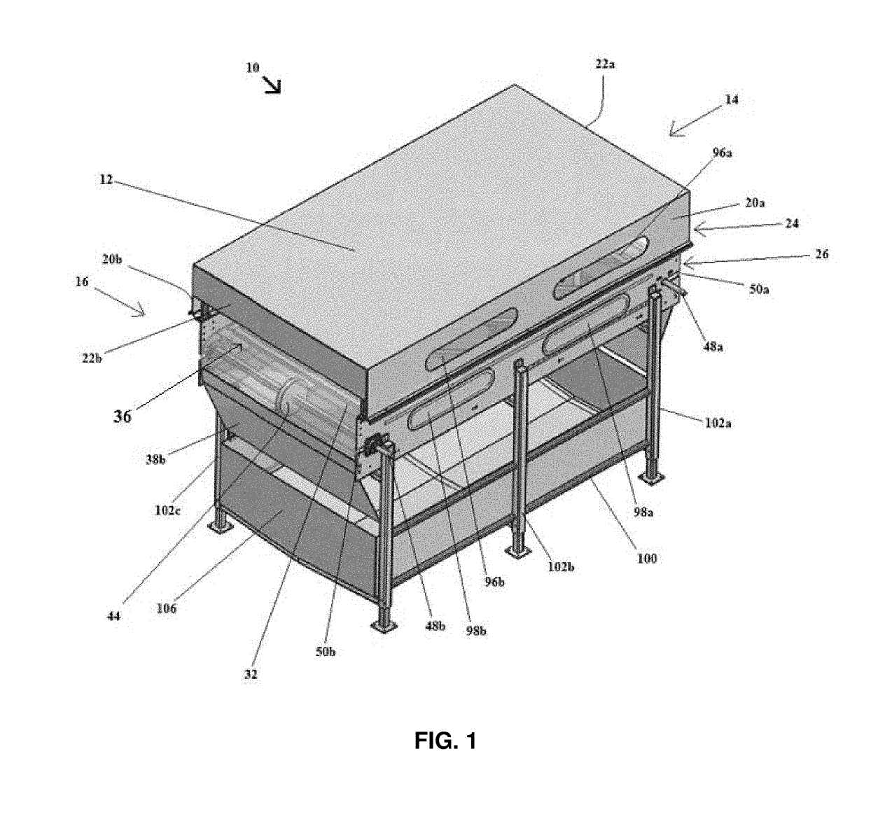

Referring now to FIGS. 1-4, a produce washer 10 includes a modular housing 12 extending from a first end 14 to a second end 16. The housing 12 is referred to as modular simply because the produce washer 10 is described as having different zones where different functions occur. The modular housing 12 has a plurality of zones 62, 64, 66 extending between the first end 14 and the second end 16. However, the modular housing 12 need not have walls or other partitions between zones. Rather, an exemplary modular housing 12 includes a ceiling 18, two side walls 20a, 20b, two end walls 22a, 22b, and a base 25. The side walls 20a, 20b include an upper portion 24 and a lower portion 26, as explained in more detail below. The modular housing 12 may be constructed from, for example, stainless steel, metal, plastic, or combinations thereof. In one non-limiting example, the entire modular housing is made from stainless steel.

The modular housing 12, and therefore the produce washer 10, can be customized in size. For example, the modular housing 12 can be made with a width of about 48 inches, or about 60 inches. Many other sizes are possible. The skilled person will recognize that the ideal size of the produce washer 10 will depend on the intended use of the produce washer 10.

An extended platform 28 may be disposed within the upper portion 24 of the modular housing 12. The extended platform 28 may extend any length through the modular housing 12, and can be connected thereto via mounts 30 on the side walls 20a, 20b. The extended platform 28 may provide attachment points for various nozzles, and may house piping for such nozzles.

A conveyor belt 32 runs through the modular housing 12, from the first end 14 to the second end 16. The conveyor belt 32 can be accessed at the first end 14, and can be accessed at the second end 16, and is generally configured to transport objects (such as produce) thereon from the first end 14 to the second end 16. The first and second ends 14, 16 provide access to the conveyor belt at a first access point 34 and a second access point 36, respectively. The access points 34, 36 are openings in the end walls 22a, 22b of the modular housing 12 where a user can access the conveyor belt 32. Optionally, the modular housing 12 may include end flaps 38a, 38b, which can be used to cover the access points 34, 36 at the respective ends 14, 16. The modular housing 12 may further include external hooks 40 which can lock the end flaps 38a, 38b in place.

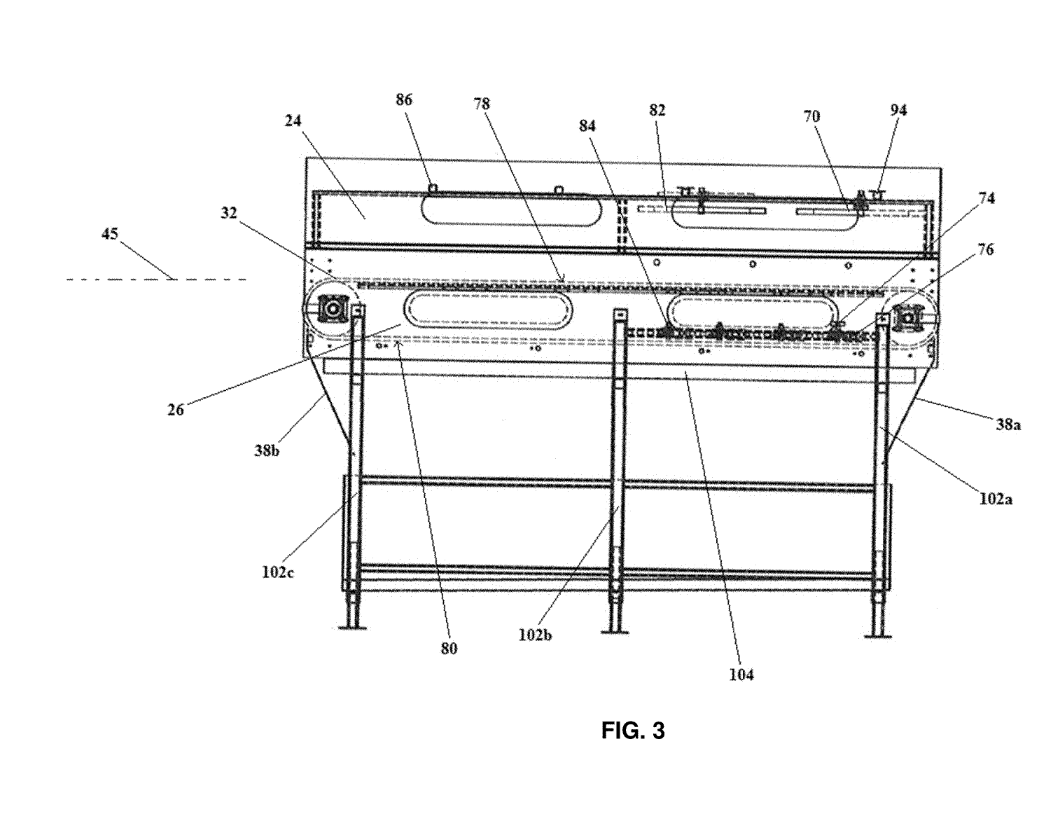

As seen in FIG. 3, the conveyor belt 32 is generally configured in a loop that runs from a first roller 42 at the first end 14 of the modular housing 12 to and around a second roller 44 at the second end 16 of the modular housing 12, and then back to and around the first roller 42, and so on. When returning to the first roller 42 from the second roller 44, the conveyor belt 32 runs below the plane 45 defined by the path of the conveyor belt 32 running from the first roller 42 to the second roller 44. The path from the first roller 42 to the second roller 44 may be referred to herein as the first path 78, and the path from the second roller 44 to the first roller 42 may be referred to herein as the second path 80. In this manner, the conveyor belt 32 forms an endless loop. Optionally, the conveyor belt 32 may be configured to run in reverse.

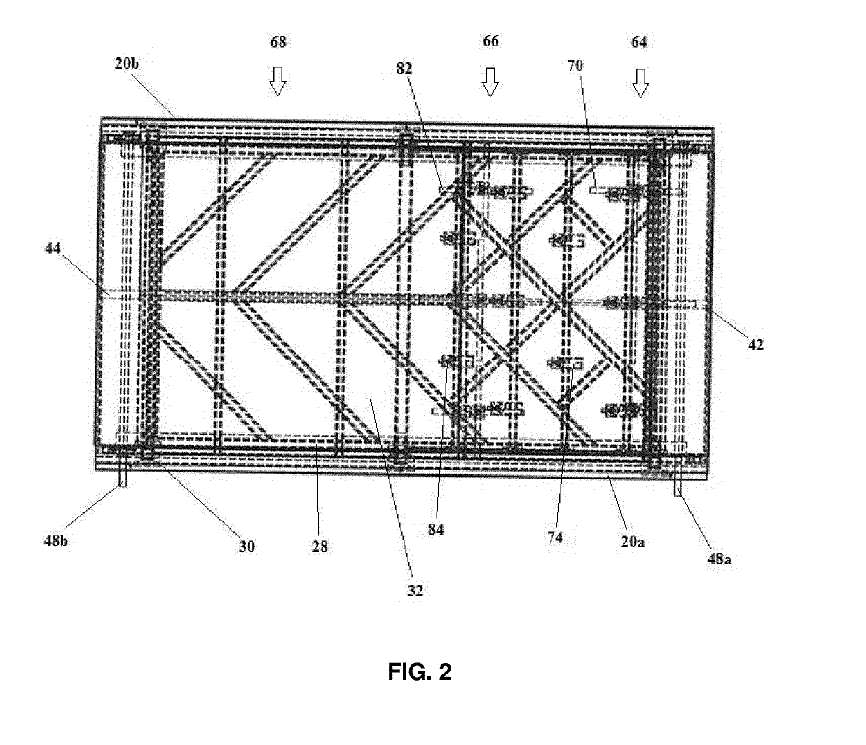

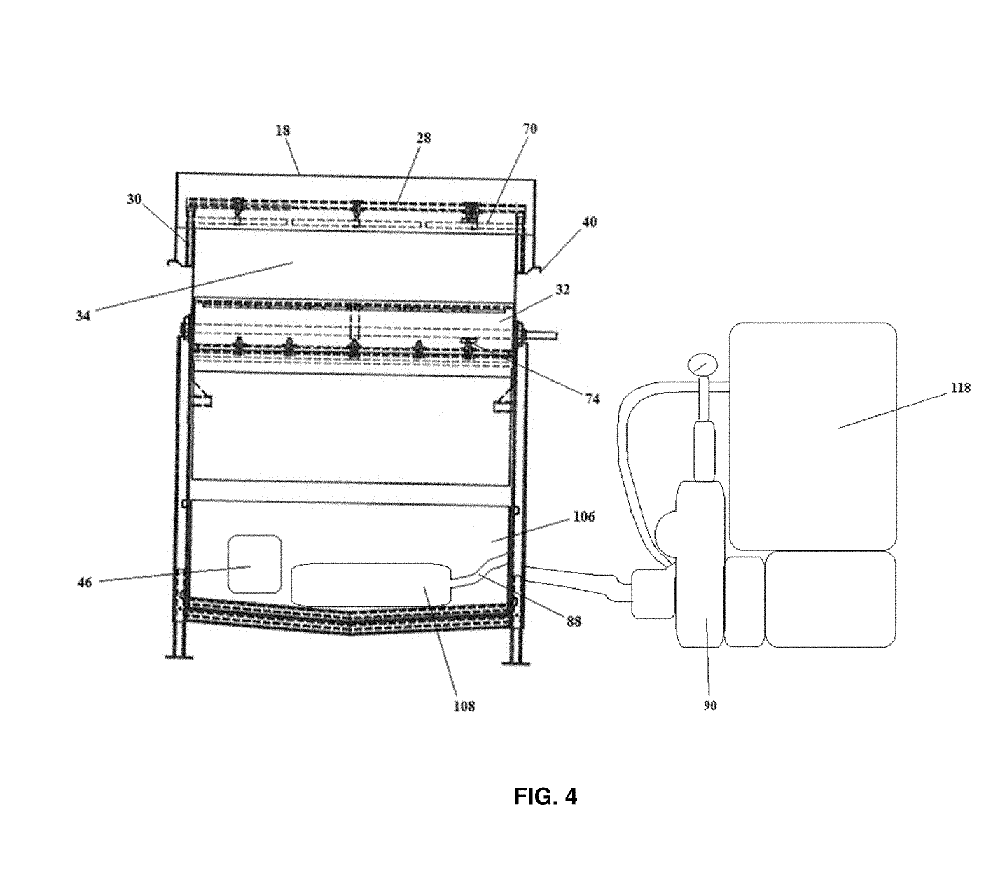

The conveyor belt may be run by a variable frequency drive motor 46. Alternatively, the conveyor belt 32 may be manually powered via turnable shafts 48a, 48b, as seen in FIG. 2 and FIG. 4, which rotate the rollers 42, 44 so as to move the conveyor belt 32. The shafts 48a, 48b can also be used to remove the rollers 42, 44 from the produce washer 10, if necessary, for instance for cleaning purposes, via slits 50a, 50b in the side walls 20a, 20b of the modular housing 12.

The conveyor belt 32 is made of a hygienic material. In certain embodiments, the conveyor belt 32 is made of a material certified by the National Sanitation Foundation (NSF) as suitable for commercial foodservice equipment. Suitable hygienic materials include, but are not limited to, polypropylene, polyethylene, polyoxymethylene, polyacetal, or combinations thereof. It is understood that embodiments of the produce washer 10 where the conveyor 32 is made from a non-hygienic material are not optimal for produce washing purposes, but are nonetheless encompassed within the present disclosure. Furthermore, the conveyor belt 32 includes a plurality of openings 52 in the belt, which are configured to allow a liquid to be sprayed therethrough. The purpose of the openings 52 is to facilitate the rinsing or spraying of objects on the conveyor belt 32 with a liquid from one or more nozzles disposed below the conveyor belt 32, or at least disposed below the plane 45 defined by the first path 78 of the conveyor belt 32. In some embodiments, the conveyor belt 32 includes various optional features such as wide modules and eyelets, a continuous drive bar which facilitates easy cleaning, and/or a cut-resistant surface.

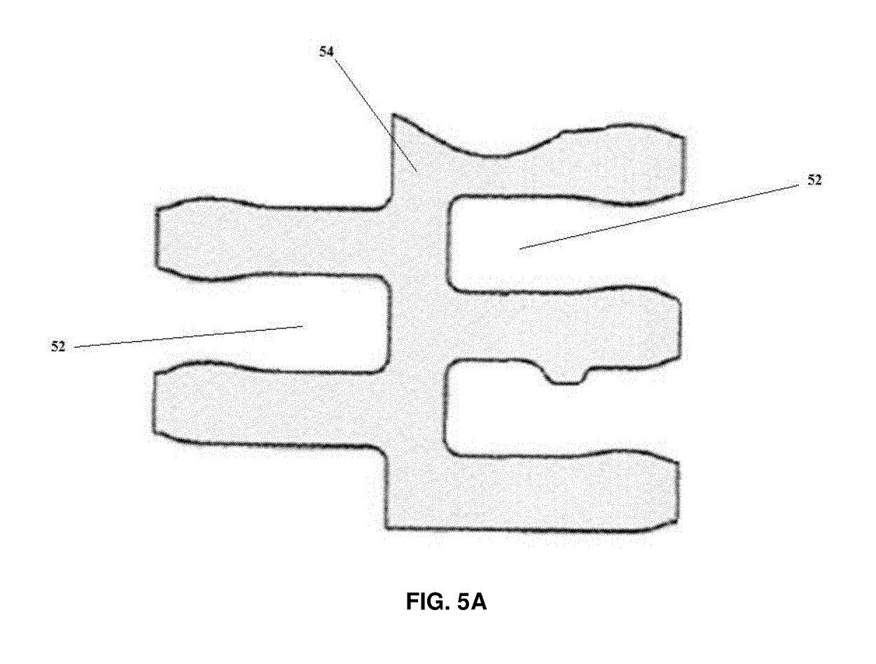

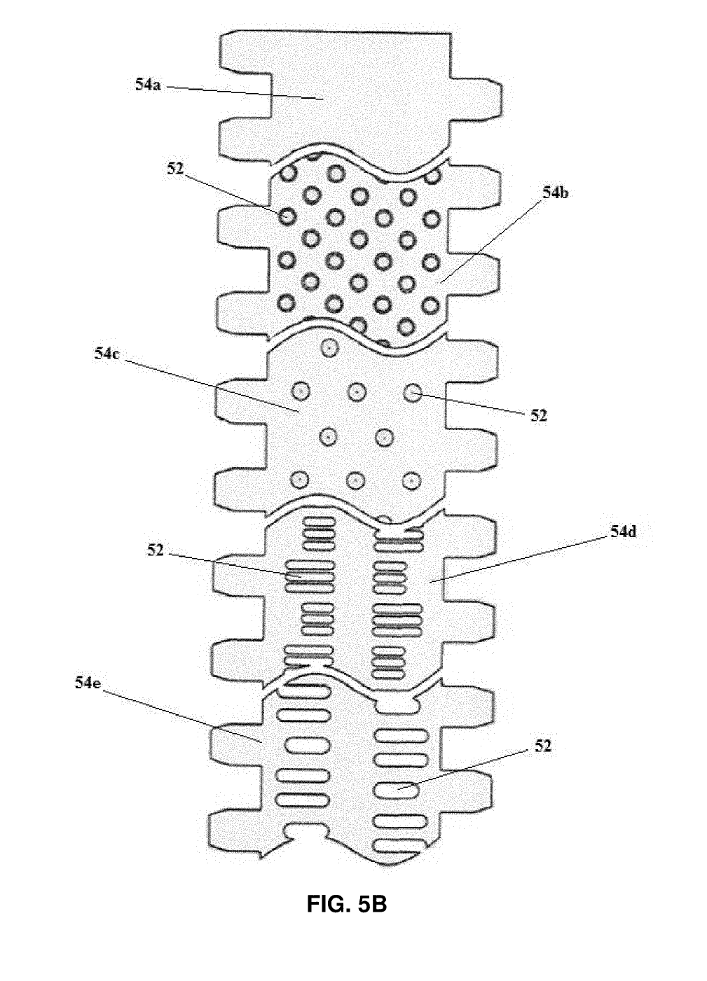

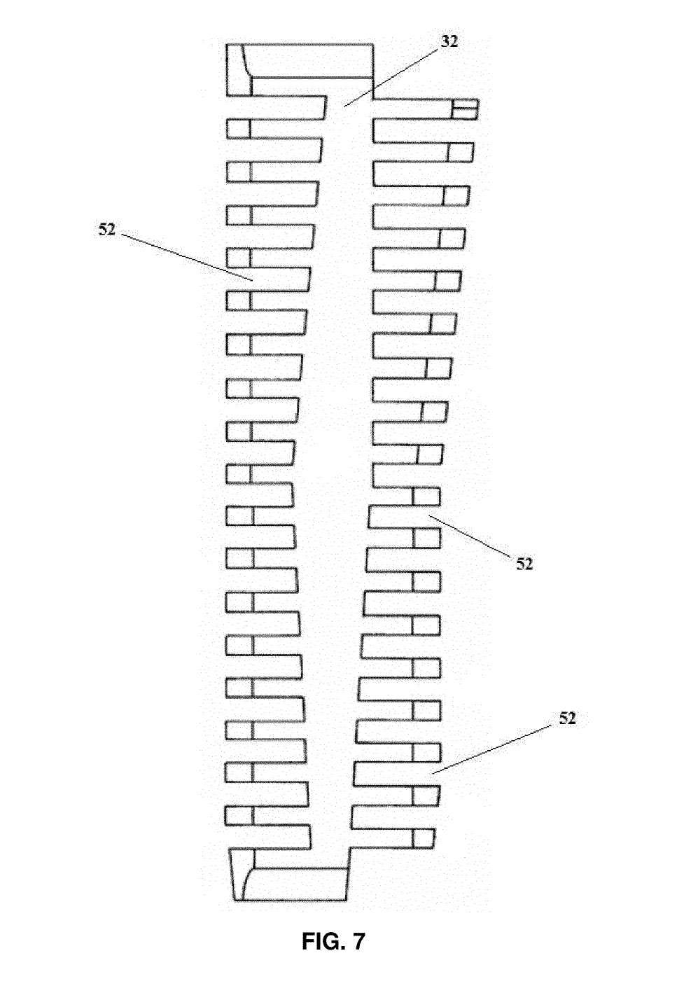

The openings 52 can be arranged in any suitable pattern and quantity. FIGS. 5A-5B, 7 show non-limiting example arrangements of openings 52 in the conveyor belt 32. The openings 52 may take the form of small pores, or may be large openings spanning a significant amount of the belt's surface area. For example, the openings 52 may be a series of small pores, on the order of a few millimeters in diameter, or may be large openings which cumulatively result in from about 1% to about 50% of the belt's surface area being open to the passage of water (or other liquid) therethrough. In one non-limiting example, the openings 52 result in about 36% of the conveyor belt's surface area being open to the passage of water. The openings 52 of the conveyor belt 32 also provide for good air circulation and drainage.

It is understood that many different arrangements of openings 52 are possible and encompassed within the present disclosure. In one embodiment, the conveyor belt 32 is composed of segments 54 having the configuration shown in FIG. 5A. In this embodiment, the conveyor belt 32 provides about 36% openness for water (or other liquid) passage through the belt 32, and about 20% contact area. Different example embodiments of conveyor belt segments 54a, 54b, 54c, 5d, 54e are shown in FIG. 5B. However, it is understood that other configurations of the conveyor belt segments 54 are possible and encompassed within the present disclosure.

One non-limiting example of a suitable conveyor belt 32 is the Series 6.1-36 FLT belt commercially available from Siegling Prolink. This particular example conveyor belt 32 has openings 52 of various sizes, with the largest opening being about 11.7×15.2 mm (0.46×0.60 in). The length of the conveyor belt 32 ultimately depends on the length of the produce washer 10 from the first end to the second end. In some embodiments, the first path 78 of the conveyor belt 32 (i.e., from the first roller 42 to the second roller 44) is about 10 feet. In such embodiments, the total length of the conveyor belt 32 is slightly more than 20 feet, since the conveyor belt 32 forms an endless loop around the first and second rollers 42, 44. However, it is understood that the length of the produce washer 10, and therefore the length of the conveyor belt 32, is customizable for any particular purpose or desired length. Furthermore, it is possible that multiple conveyor belts, such as a series of three or more endless loops around six or more rollers, can be employed within the modular housing such that conveyor belts having a length significantly shorter than that of the produce washer 10 from the first end 14 to the second end 16 can be utilized.

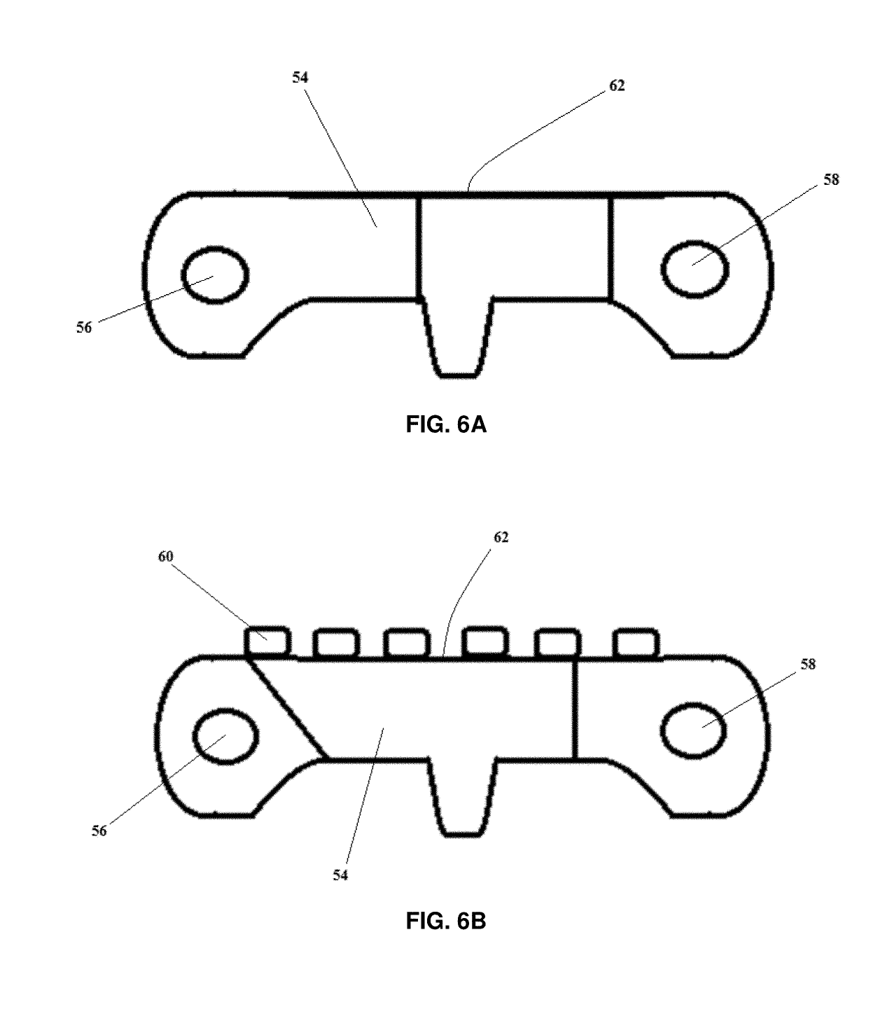

In some embodiments, the conveyor belt 32 is a modular conveyor belt, composed of interlinked segments 54. FIG. 5A shows a view of an exemplary embodiment of a conveyor belt segment 54 from the top. Each segment 54 in a modular conveyor belt 32 may or may not have a different pattern or configuration of openings 52. FIG. 5B shows a series of modular conveyor belt segments 54a, 54b, 54c, 5d, 54e each having a different configuration of openings 52. A modular conveyor belt 32 utilizes connecting rods inserted through connecting channels 56, 58 in the belt segments 54. Each belt segment 54 typically has a first connecting channel 56 and a second connecting channel 58, where the first and second connecting channels 56, 58 are parallel to each other so as to provide a substantially level belt surface 62 (without regard for optional teeth 60 or other gripping means on the belt surface 62). Connecting channels 56, 58 can be seen in the belt segments 54 depicted in FIGS. 6A-6B. Connecting rods join the individual belt segments 54 together by extending between two or more segments 54 through aligned connecting channels 56, 58 therein. In some embodiments, a first connecting rod runs between and connects the first connecting channels 56 of a first segment 54a and a second segment 54b, and a second connecting rod runs between and connects the second connecting channels 58 of the second segment 54b and a third segment 54c, and so on until a loop of a desired length is formed. The connecting rods may be made of stainless steel or any other suitable material for joining the individual belt segments 54 together. As seen in FIG. 6B, the conveyor belt 32 may optionally include teeth 60 on its surface 62 for enhanced gripping of objects. This is especially advantageous given that objects within the produce washer 10 become wet from the spraying of liquid.

Alternatively, the conveyor belt 32 may be formed from a single piece of material, or otherwise not be assembled from modular components, as shown in FIG. 7. As seen in FIG. 7, the conveyor belt 32 nonetheless includes openings 54 for the passage of water or other liquid.

For ease of reference, the terms “above” and “below” are used herein to describe the positioning of nozzles or other elements or features relative to the conveyor belt 32 or the surface 62 of the conveyor belt. It is understood that these terms are relative to the surface 62 of the conveyor belt 32 on which objects may be transported along the first path 78. Therefore, the phrases “above the conveyor belt” or “above the conveyor belt surface” or “above the top surface of the conveyor belt” all refer to an area or location within the modular housing 12 between the surface 62 of the conveyor belt 32, as the conveyor belt 32 runs from the first roller 42 to the second roller 44, and the ceiling 18 of the modular housing 12. Similarly, the phrase “below the conveyor belt surface” or “below the conveyor belt” refer to an area or location within the modular housing 12 but from which a liquid would need to pass through the openings 52 in the conveyor belt 32 at least once in order to contact an object disposed on the conveyor belt 32. Moreover, the terms “top surface” and “bottom surface” are used to refer to the same outer (with respect to the loop) surface 62 of the conveyor belt 32 depending on whether the conveyor belt 32 is on the first path 78 or the second path 80. That is, the “top surface” is the surface 62 of the conveyor belt 32 as the conveyor belt 32 runs along the first path 78, from the first roller 42 to the second roller 44, and the outer (with respect to the loop) surface is the surface 62 of the conveyor belt 32 as the conveyor belt 32 runs along the second path 80, from the second roller 44 to the first roller 46, respectively. In other words, the terms “above” and “below” are used with respect to the plane 45 defined by the first path 78 of the conveyor belt 32 (i.e., when running between the first roller 42 and the second roller 44). In this manner, features “below the conveyor belt” may nonetheless be positioned inside the loop formed by the conveyor belt's path, because such features are below the plane 45 defined by the conveyor belt 32 when running from the first roller 42 to the second roller 44.

As noted above, the modular housing 12 typically encompasses a plurality of zones 64, 66, 68 configured for different purposes, with the conveyor belt 32 running from the first end 14, through each of the zones 64, 66, 68, to the second end 16, and being configured to transport objects on the conveyor belt 32 from the first belt access point 34 at the first end 14, through each zone 64, 66, 68, to the second belt access point 36 at the second end 16. For example, the produce washer 10 may include a washing zone 64, a rinsing zone 66, and a sanitation zone 68. Alternatively, the producer washer 10 may include just a washing zone 64 and a sanitation zone 68. In any embodiment, the produce washer 10 may further include a drying zone. However, a producer washer 10 encompassing only one zone, such as a washing zone 64, is also encompassed by the present disclosure.

The produce washer 10 may include a washing zone 64. In the washing zone 64, one or more nozzles 70, 74 are disposed within the modular housing 12 above the conveyor belt 32, and are configured to spray a liquid, such as water, onto objects being transported along the conveyor belt 32 through the washing zone 64 (or objects which are stationary on the conveyor belt 32 within the washing zone 64) from both above and below the conveyor belt 32. Upper washing zone nozzles 70 may be attached to the ceiling 18, the extended platform 28, and/or the side walls 20a, 20b of the modular housing 12 in the washing zone 64. Regardless of positioning, the upper washing zone nozzles 70 are configured to spray a liquid, such as water, onto objects from above the conveyor belt 32.

Lower washing zone nozzles 74 are disposed below the conveyor belt 32 and are configured to spray a liquid, such as water, onto objects through the openings 52 in the conveyor belt 32. Thus, the openings 52 in the conveyor belt 32 facilitate better washing of the objects. The lower washing zone nozzles 74 may be disposed either on the base 25 of the modular housing 12 or on a platform 72 interposed between the first path 78 and second path 80 of the conveyor belt 32. The platform 76 is mounted to the side walls 20a, 20b in the lower portion 26 of the modular housing 12. When the lower washing zone nozzles 74 are disposed on the base 25 of the modular housing 12, they spray the liquid through openings 52 in the conveyor belt 32 twice (i.e., through openings 52 in the conveyor belt 32 travelling along the second path 80 and then through openings 52 in the conveyor belt 32 travelling along the first path 78) before reaching the objects on the conveyor belt 32. When the lower washing nozzles 74 are disposed on a platform 72 interposed between the top and bottom surfaces of the conveyor belt 32, they need only spray through openings 52 in the conveyor belt 32 once before the sprayed liquid reaches objects on the conveyor belt 32.

It is understood that the nozzles referred to herein may include any apparatus configured to spray a liquid. In some embodiments, the nozzles in the produce washer, such as the nozzles in the washing zone, include spinner nozzles. A spinner nozzle is a nozzle which spins or rotates while spraying. Some spinner nozzles are capable of 360° spraying. In other embodiments, the nozzles are directional nozzles. A directional nozzle is a nozzle which swivels or pivots while spraying.

In some embodiments, the washing zone 64 is the first zone objects enter upon entering the produce washer 10 at the first end 14. In one non-limiting example, the washing zone 64 has 24 overhead spinner nozzles 70 above the conveyor belt surface, 20 spinner nozzles 74 underneath the conveyor belt surface 62, and 6 directional nozzles 70 on the side walls 20a, 20b of the modular housing 12. With this configuration of nozzles 70, 74 in the washing zone 64, objects on the conveyor belt 32 are greeted by a barrage of sprayed liquid from all sides.

The produce washer 10 may include a rinsing zone 66, or may utilize the features of the washing zone 64 to perform a rinsing cycle. In the rinsing zone 66, one or more nozzles 82 are disposed within the modular housing above the conveyor belt 32, and are configured to spray a liquid, such as water, onto objects being transported along the conveyor through the rinsing zone. Alternatively, the upper washing zone nozzles 70 can be utilized to perform the functions of the rinsing zone 66.

The rinsing zone nozzles 82 may be attached to the ceiling 18 of the modular housing 12, to the extended platform 28 within the modular housing 12, and/or to the side walls 20a, 20b of the modular housing 12. The rinsing zone 66 may include, for instance, high-volume nozzles that spray fresh water onto objects on the conveyor belt surface 62 from the ceiling 18 of the modular housing 12. This is advantageous for produce washing because it facilitates the removal of any remaining soil on the produce. In one non-limiting example, the rinsing zone 66 has 4 overhead high-volume nozzles. Optionally, the rinsing zone 66 may include one or more nozzles 84 disposed below the conveyor belt 32, as in the washing zone 64. This optional feature is seen in FIG. 3. When present, the lower rinsing zone nozzles 84 can be disposed on the same platform 76 as the lower washing zone nozzles 74.

The produce washer 10 may include a sanitation zone 68. In the sanitation zone 68, one or more nozzles 86 are disposed within the modular housing 12 and are configured to spray a sanitized liquid, such as water, onto objects traversing or disposed in the sanitation zone 68 on the conveyor belt 32. The sanitation zone nozzles 86 may be attached to the ceiling 18 of the modular housing 12, to the extended platform 28 within the modular housing 12, and/or to the side walls 20a, 20b of the modular housing 12. Optionally, the sanitation zone 68 may also include one or more nozzles disposed below the conveyor belt 32, as in the washing zone 64.

The produce washer 10 may include a drying zone. In the drying zone, one or more blow dryers are disposed within the modular housing 12 and are configured to blow hot air on objects within the drying zone on the conveyor belt 32. The blow dryers can be attached to the ceiling 18 of the modular housing 12, to the extended platform 28, and/or to the side walls 20a, 20b. Alternatively, a drying operation may be performed external to the modular housing 12. For example, produce exiting the produce washer 10 may be manually dried or transported to an external drying zone or apparatus.

Once objects have traversed the conveyor belt 32 from the first end 12 to the second end 14, the objects are generally removed from the produce washer 10 manually, or by the aid of the gravity. For example, the conveyor belt 32 can be configured to drop objects exiting the produce washer 10 at the second end 14 into a desired container.

Though the produce washer 10 is described with reference to multiple “zones”, it is understood that the function of two or more zones may be accomplished by overlapping features or elements. In other words, a produce washer 10 may include a washing zone 64 and a rinsing zone 66 as described above, but these zones may inhabit an overlapping or even identical amount of physical space within the modular housing 12. In some embodiments, the washing zone 64 and the rinsing zone 66 utilize the same overhead nozzles. Moreover, many different combinations of zones and functions are possible, and the skilled person will recognize that such combinations are customizable for the desired purpose. In any event, the particular combination or configuration of zones or functions of the produce washer is not critical.

Each of the nozzles configured to spray a particular liquid can be supplied by the same source of the liquid through suitable piping or tubing, with or without the use of a pump 90. The pipes, tubes, or hoses 88 can be run from the nozzles through channels within the walls 20a, 20b, 22a, 22b, ceiling 18, or base 25 of the modular housing 12, or may be entirely external to the modular housing 12 with each nozzle having a connection port 94 for attachment to a hose on the outer surface of the modular housing 12. Suitable piping or tubing 88 may be included to transport the desired liquids to the particular nozzles within the produce washer 10. For example, piping 88 may be run down the sides of the modular housing 12, such as at the position of each leg 102. The legs 102 may be hollow, and may be used to house portions of piping 88. The skilled person will recognize that many suitable locations and paths may be used for piping or hoses 88 to transport liquids to the nozzles 70, 74, 82, 84, 86. Moreover, the produce washer 10 may include one or more pumps 90, such as peristaltic pumps, to deliver the liquids from one or more liquid supplies 108 (if not already pressurized) to the nozzles 70, 74, 82, 84, 86. As a non-limiting example, the nozzles 70, 74, 82, 84, configured to spray water may each be connected directly to a running water source, and therefore not require a pump to supply the liquid to the nozzles 70, 74, 82, 84, while the nozzles 86 configured to spray sanitized water can be connected to a supply 108 of sanitized water which is fed to the nozzles 86 through hosing 88 by a peristaltic pump 90.

In some embodiments, the produce washer 10 is completely free of any brushes. This is advantageous, as brushes can cause damaging or bruising of soft produce, and can also be a source of contamination.

As described above, the side walls 20a, 20b of the modular housing 12 include upper and lower portions 24, 26. The upper portion 24 of each side wall 20a, 20b may include windows 96a, 96b which allow an observer to see into the modular housing at a level above the conveyor belt 32, so as to observe the washing of objects on the conveyor belt 32. The lower portion 26 of each side wall 20a, 20b may include windows 98a, 98b which allow an observer to see into the modular housing 12 at a level below the first path 78 of the conveyor belt 32, so as to observe the operation of the nozzles disposed below the first path 78 of the conveyor belt 32. Any of the windows 96, 98 may be covered, such as depicted in FIG. 1. Furthermore, any of the windows 96, 98 may be opened or removed to allow access into the modular housing 12 from the side. This facilitates easier cleaning of the produce washer 10.

The modular housing 12 can be supported on any suitable stand structure 100. The stand structure 100 may include six legs 102 and a platform 104. The legs 102 may either directly support the modular housing 12 or support the platform 104, in which case the modular housing 12 rests on the platform 104 (as seen in FIG. 3). The stand structure 100 can be configured to hold the produce washer 10 level to the ground, or, alternatively, to tilt the produce washer 10 at an angle. For example, in one embodiment, the first set of legs 102a, at the first end 12 of the produce washer 10, can be taller than the second set of legs 102b, in between the first and second ends 12, 14 of the produce washer 10, and even taller than the third set of legs 102c, at the second end 16 of the produce washer 10. This results in the produce washer 10 being tilted at an angle such that the first end 14 is at a different height off the ground from the second end 16. This tilted angle configuration facilitates easier movement of objects along the conveyor belt 32 through the help of gravity. Alternatively, the conveyor belt 32 may be positioned at an angle between the first end 12 and the second end 14 while the modular housing 12 is level (that is, the conveyor belt 32 may be a descent or incline belt), thereby producing the same tilted angle benefit.

The stand structure 100 may further include a cabinet 106 for housing one or more of the drive motor 46, a supply 108 of water, sanitized water, or other liquid, or other equipment such as a pump 90. In one non-limiting example, the cabinet 106 only houses a tank 108 of sanitized water. In one non-limiting example, the stand structure 100 includes the drive motor 46 and a tank 108 of sanitized water, but a pump 90 and a filtration system 118 are external to the produce washer 10. It is understood that features such as the drive motor 46, tank 108, pump 90, and filtration system 118, can each be external to the produce washer or housed within the stand structure 100. Suitable example pumps include the Velocity VVF-5 booster pump system. The filtration system 118 can be used to filter the water or other liquid being sprayed within the modular housing 12. The filtration system 118 may also allow for some of the sprayed liquid to be recycled. Furthermore, the cabinet 106 can be used to store objects, such as produce, before or after being subjected to the washer. In some embodiments, the cabinet 106 houses the drive motor 46 which powers the conveyor belt 32 (and, optionally, may be used to power various inlet or exit attachments), a supply 108 of sanitized water, and a pump 90, and further includes hosing 88 configured to supply the nozzles 86 in the sanitization zone 68 with sanitized water from the supply 108. In other embodiments, the supply 108 of sanitized water can be external to the produce washer 10.

In some embodiments, the modular housing 12 further includes internal flaps, composed of a hygienic material such as polypropylene, which serve to segregate the different zones. In this manner, for instance, the spraying of sanitized water in the sanitation zone 68 does not result in sanitized water being sprayed into the rinsing zone 66 or the washing zone 64.

An example method of using an embodiment of a produce washer as disclosed herein will now be described. Upon entering the produce washer via a hygienically friendly polypropylene pro-link modular belt, produce is greeted by a barrage of water from all sides. In this one non-limiting example, 24 overhead spinner nozzles rain down while 20 spinner nozzles take care of cleaning the bottom side from underneath. All the spinner nozzles are aided by directional nozzles on the sides the produce washer. In this one non-limiting example, the produce washer has 6 directional nozzles on the sides. After leaving the wash area, the produce enters the fresh water rinse cycle where overhead high volume nozzles flush away any remaining soil. In this one non-limiting example, the produce washer has 4 overhead high volume nozzles to accomplish the rinse cycle. Next, the produce continues into the sanitation cycle, where more overhead nozzles spray sanitized water over the produce. After sanitation, the produce either leave the produce washer or meets the optional overhead blow dryers. The ride across the conveyor belt in this one non-limiting example is about 10 feet, and takes less than one minute. More specifically, the ride across the conveyor belt takes from about 15 seconds to about 30 seconds. The conveyor belt is driven by a variable frequency drive motor. In this non-limiting example, the conveyor belt runs level to the ground.

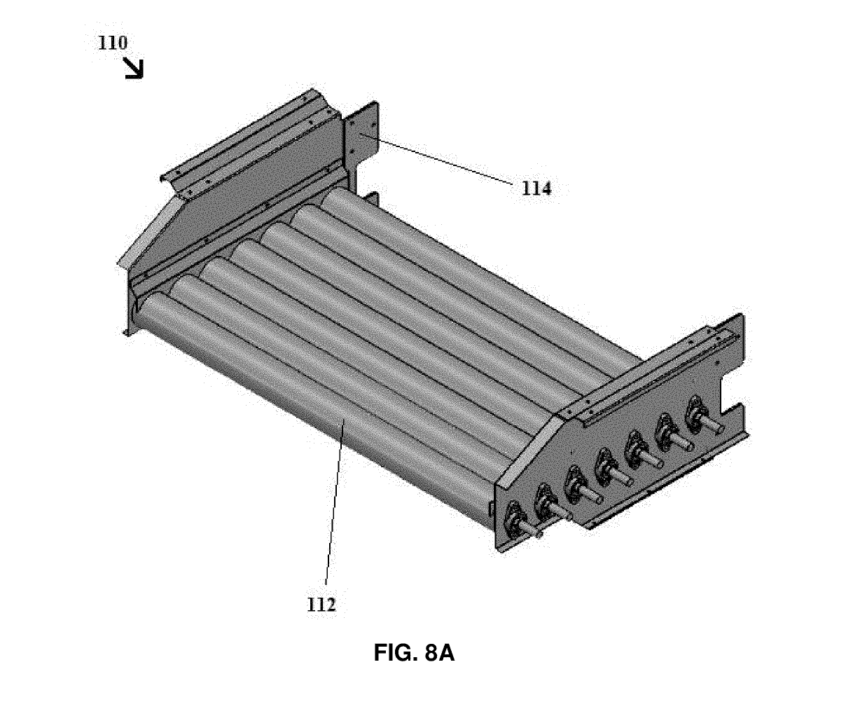

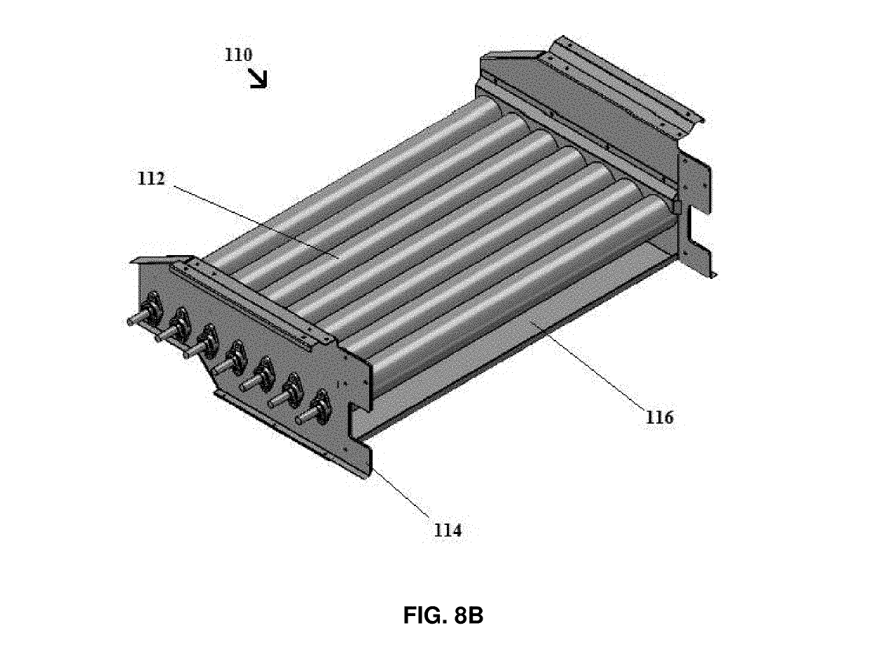

Methods of using the produce washer may further include regular cleaning steps, as soil or other contaminants may build up over time inside the produce washer after being sprayed off of produce. Furthermore, the produce washer may further include a filtration system for purifying the water or other liquid used in the apparatus. Many other optional features, such as a waxer 110, and related functions are also available. An example waxer 110, depicted in FIGS. 8A-8B, includes a series of rollers 112 which may be covered in a wax or other desired material. The wax or other material may be housed in a compartment 116 below the rollers 112. The waxer 112 is connected to the second end 16 by flanges 114. Produce or other objects roll onto the waxer 112 after exiting the modular housing 12 at the second end 16, and accumulate wax on their surface from contact with the rollers 112. The objects then roller off the waxer 112 or can be manually removed therefrom.

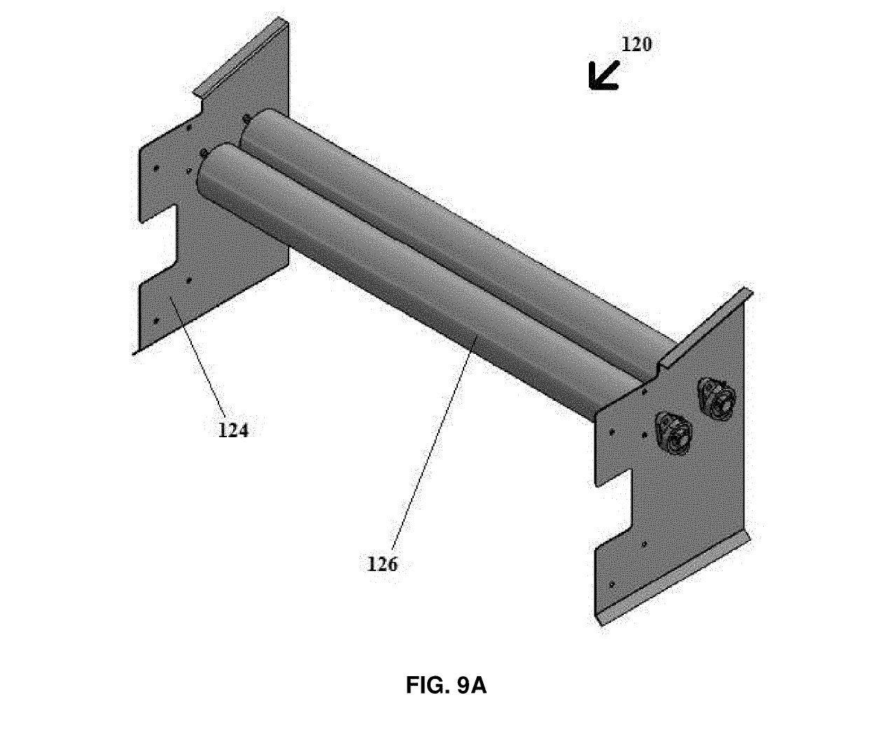

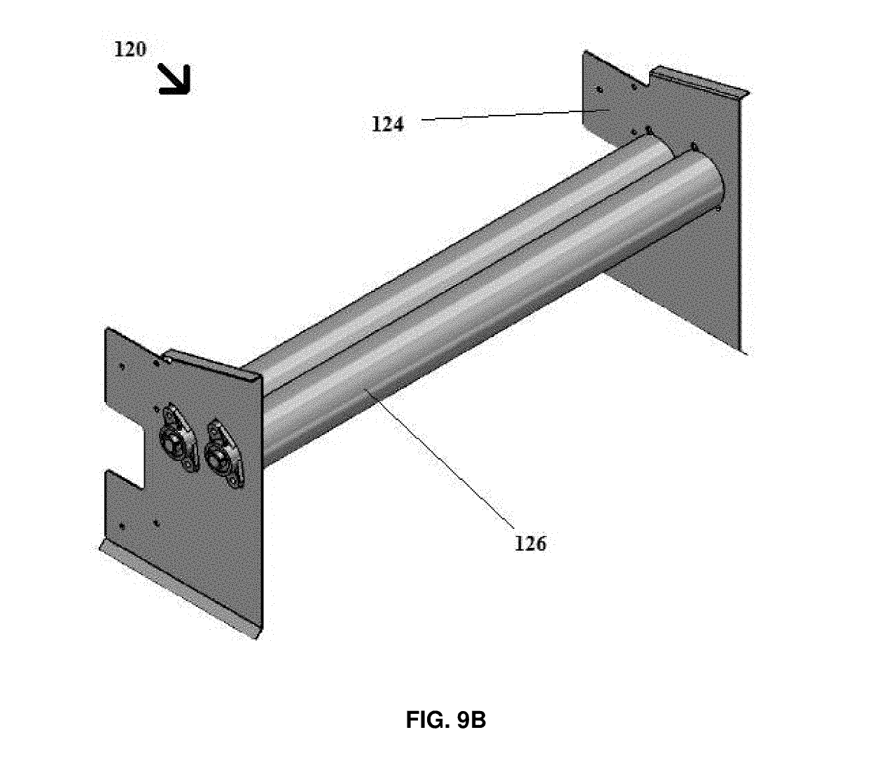

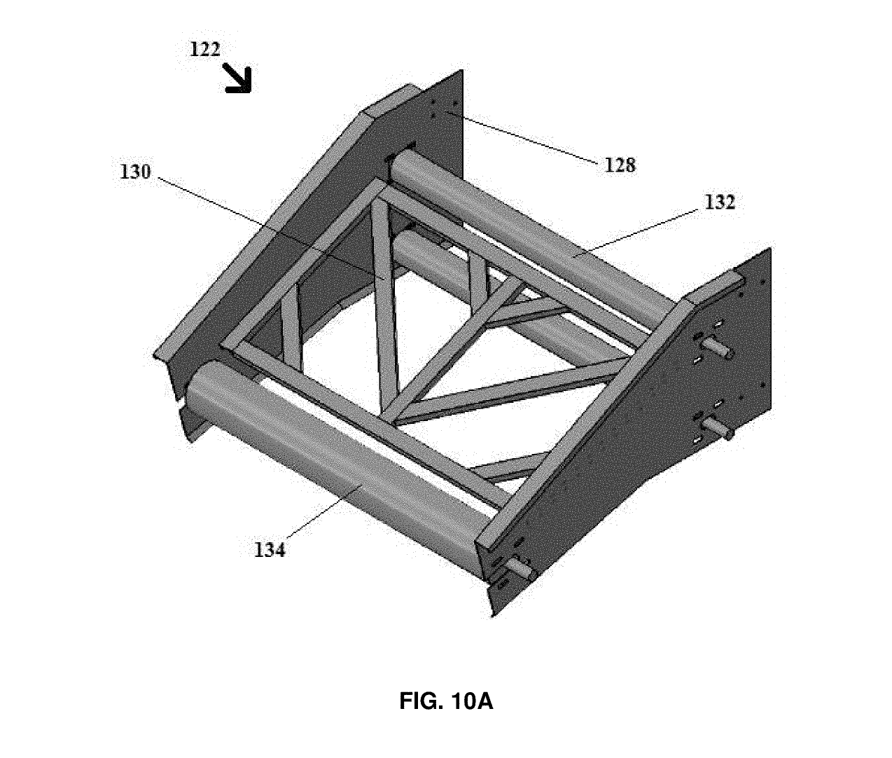

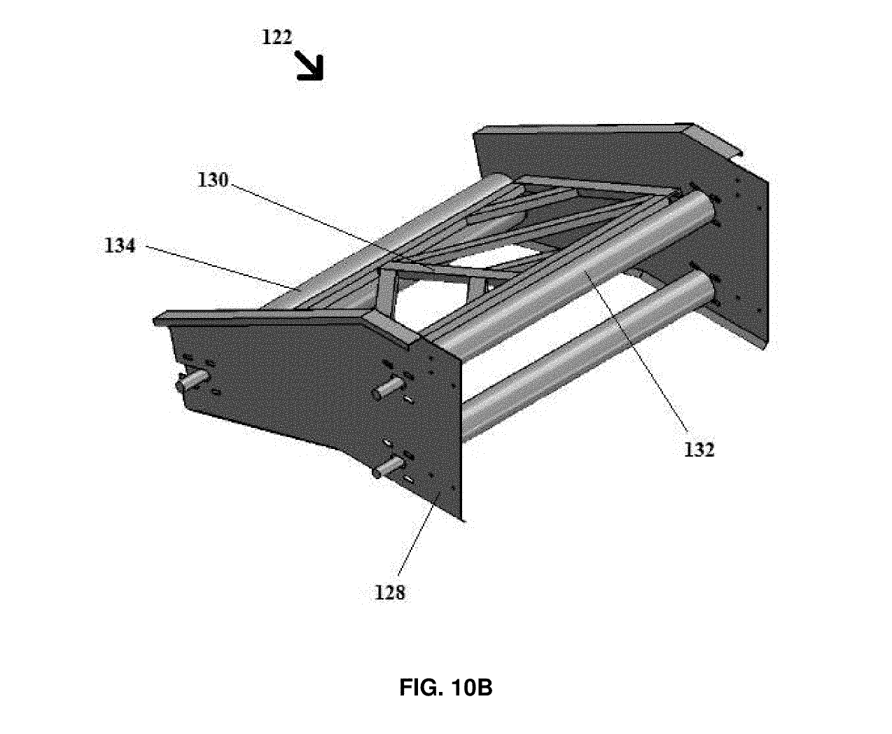

Furthermore, the produce washer 10 may optionally include an entrance roller kit 120 connected to the first end 14 and/or an exit conveyor 122 connected to the second end 16. The entrance roller kit 120 and exit conveyor 122 help facilitate easier loading and unloading of the produce washer 112 by users. The entrance roller kit 120, depicted in FIGS. 9A-9B, attaches to the first end 14 by suitable connection means (e.g., bolts, screws, nails, or the like) via flanges 124. The entrance roller kit 120 includes at least two rollers 126 which are angled so as to form a path descending into the first end 14. Similarly, the exit conveyor 122, depicted in FIGS. 10A-10B, attaches to the second end 16 by suitable connection means (e.g., bolts, screws, nails, or the like) via flanges 128. The exit conveyor 122 includes an angled descent ramp 130 which objects exiting the conveyor belt 32 at the second end 14 naturally fall onto. The descent ramp 130 can be formed of a solid piece of material, or may be composed of a series of rails or bars. The descent ramp 130 is generally interposed between a first exit roller 132, near the flanges 138, and a second exit roller 134. The first exit roller 132 is elevated relative to the second exit roller 134.

Certain embodiments of the apparatus and methods disclosed herein are defined in various example embodiments. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A produce washer comprising:
a modular housing having a plurality of zones extending between a first end and a second end; and
a conveyor belt comprising a hygienic material and defining a conveyor belt surface running through the plurality of zones from the first end to the second end, the conveyor belt being configured to transport items on the conveyor belt surface from the first end to the second end, wherein the conveyor belt comprises openings configured to allow a liquid to be sprayed therethrough;
the plurality of zones defining a washing zone and a sanitation zone, wherein:
the washing zone comprises (i) nozzles disposed above the conveyor belt surface configured to spray a liquid onto objects traversing or within the washing zone on the conveyor belt surface, and (ii) nozzles disposed below the conveyor belt surface configured to spray a liquid onto objects traversing or within the washing zone on the conveyor belt surface through the openings in the conveyor belt; and
the sanitation zone comprises nozzles configured to spray a sanitized liquid onto objects traversing or within the sanitation zone on the conveyor belt surface from above the conveyor belt surface.

2. The produce washer of claim 1, wherein the washing zone further comprises directional nozzles on a side wall of the modular housing configured to spray a liquid onto objects traversing or within the washing zone on the conveyor belt surface.

3. The produce washer of claim 1, wherein the produce washer further comprises a rinsing zone, wherein the rinsing zone comprises nozzles configured to spray a liquid onto objects traversing or within the rinsing zone on the conveyor belt surface from above the conveyor belt surface.

4. The produce washer of claim 1, wherein the produce washer further comprises a drying zone comprising one or more overhead blow dryers.

5. The produce washer of claim 1, wherein the produce washer is free of brushes.

6. The produce washer of claim 1, comprising one or more windows in the modular housing configured to allow observation into the produce washer.

7. The produce washer of claim 1, wherein the produce washer is substantially level to a surface supporting the produce washer.

8. The produce washer of claim 1, wherein the produce washer is tilted at an angle such that the first end is at a different height than the second end.

9. The produce washer of claim 1, wherein the conveyor belt is tilted at an angle such that the conveyor belt at the first end is at a different height than the conveyor belt at the second end.

10. The produce washer of claim 1, wherein the hygienic material comprises polypropylene, polyethylene, polyoxymethylene, polyacetal, or a combination thereof.

11. The produce washer of claim 1, further comprising a stand having a plurality of legs configured to support the modular housing.

12. The produce washer of claim 10, wherein the stand further supports a cabinet.

13. The produce washer of claim 12, further comprising at least one of a supply of sanitized liquid, a pump, or a drive motor configured to run the conveyor belt, disposed in the cabinet.

14. The produce washer of claim 1, wherein the openings make up about 36% of the conveyor belt surface.

15. The produce washer of claim 1, further comprising an entrance roller kit connected to the first end.

16. The produce washer of claim 1, further comprising an exit conveyor connected to the second end.

17. The produce washer of claim 1, further comprising a waxer connected to the second end, wherein the waxer comprises rollers and is configured such that objects exiting the conveyor belt accumulate wax upon traversing the rollers of the waxer.

18. A method of washing produce, the method comprising:
moving produce through a produce washer along a conveyor belt composed of a hygienic material and comprising openings configured to allow a liquid to be sprayed therethrough; and
spraying a liquid onto the produce from above the produce and from below the produce while the produce is moved through the produce washer, wherein the liquid sprayed from below the produce is sprayed through the openings in the conveyor belt.

19. The method of claim 18, wherein the produce washer is free of brushes.

20. The method of claim 18, wherein the liquid comprises water.

21. The method of claim 18, wherein the liquid comprises sanitized water.

22. The method of claim 18, wherein the openings make up about 36% of a surface of the conveyor belt.
